(19) United States
(12) Patent Application Publication
(10) Pub. No.: US 2010/0243819 A1
(43) Pub. Date: Sep. 30, 2010

(54) DEVICE FOR DELAYING BOUNDARY LAYER SEPARATION

(76) Inventors: Michel Stanislas, Villeneuve D'ASQ (FR); Jean-Marc Foucaut, Lesquin (FR); Dimitrios Kostas, Melbourne (AU); Arthur Dyment, Chereng (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/447,350

(22) PCT Filed: Oct. 31, 2007
(86) PCT No.: PCT/FR07/01810

§ 371 Date: Jun. 16, 2010

(30) Foreign Application Priority Data
Nov. 3, 2006 (FR) 06/09628

(51) Int. Cl. B64C 21/04

(52) U.S. Cl. 244/207

(57) ABSTRACT

Device for delaying the separation of a boundary layer in flow of air (10) on a wall (12), including holes (14) formed in the wall (12) and connected to compressed air supply valves (18) by means of channels (16), the frequency of the valve opening and closing cycles and the valve opening duration being selected so as to generate peak output velocities from the holes (14) which occur in quasi-continuous succession. The invention is particularly suitable for aircraft wings and motor vehicle bodies.

The invention relates to a device for delaying the separation of a boundary layer in a flow of air on a wall, such as for example an aircraft wing or a motor vehicle body.

The boundary layer separation on an aircraft wing occurs when the leading angle of the wing in relation to the flow become substantial, which occurs at take-off, landing and during the maneuvers, and results in a decrease in the lift and by the generation of a drag and therefore by a substantial decrease in the aerodynamic performance of the aircraft.

It has already been proposed, to delay this separation, to use continuous or pulsed jets, which are produced by supplying with pressurized air orifices formed in the wall and inclined for example in a direction perpendicular to the flow and at 45° in relation to the surface of the wall, these jets generating vortices that increase the friction of the flow on the wall and counter the boundary layer separation.

These jets, continuous or pulsed, are controlled by means such as solenoid valves and are generated only during the phases of flight when they are useful. Pulsed jets are not as effective as continuous jets but have the advantage of consuming less compressed air bled from an aircraft engine since this bleeding results in a decrease in the output of the engine.

This invention has in particular the objective to improve the performance of devices of the aforementioned pulsed jet type.

It proposes to this effect a device for delaying the separation of a boundary layer in an air flow on a wall, comprising orifices formed in the wall with an inclination determined in relation to the direction of the flow on the wall and in relation to the surface of the wall, ducts connecting these orifices to means of supplying pressurized air, and means of controlling means of supplying as opening and closing, characterized in that the frequency of the opening and closing cycles of the means of supplying and the duration of opening of the means of supplying in each cycle are determined in order to generate at the output of the orifices, at the opening of the valves, air speed peaks which follow one another quasi-continuously.

This determination of the frequency of the opening and closing cycles of the means of supplying and of the duration of opening of the means of supplying in each cycle makes it possible to optimize the conditions for generating pulsed jets and for using as best as possible the speed peaks created at the opening of the means of supplying, in order to approach the results obtained with continuous jets, while consuming much less compressed air.

In a preferred embodiment of the invention, the duration of opening of the means of supplying is between approximately 5 and 10 ms according to the length of the ducts. The frequency of the cycle of opening and of closing of the means of supplying is more preferably between 30 Hz and 200 Hz according to the length of the ducts.

The pressure (in relative value) of the air for supplying the orifices is between approximately 0.1 and 8 bars, the diameter of the orifices being between approximately 1 and 10 mm and the length of the supply ducts of these orifices between approximately 10 cm and 1 m.

The pulsed jets can be produced by orifices inclined in the same manner and in the same direction in relation to the surface of the wall and then generate co-rotating vortices (which rotate in the same direction).

As an alternative, the pulsed jets can be produced by orifices which are inclined in pairs in opposite directions in relation to the surface of the wall, and thus generate contra-rotating vortices (which rotate in opposite directions).

The means of supplying with pressurized air can include solenoid valves of which the inlets are connected to a source of pressurized air and the outlets to the orifices of the wall, or as an alternative, a distributor comprising a rotating tube supplied with pressurized air and comprising rows of radial holes, this tube being driven in rotation in a cylindrical housing comprising radial holes which are connected to the orifices of the wall and which are aligned axially with the holes of the rotating tube in order to be cyclically supplied with pressurized air and blocked off during the rotation of the rotating tube.

The invention applies in particular to an aircraft wing or to a motor vehicle body, the compressed air that supplies the aforementioned orifices being bled from a compressor of an aircraft engine or of a motor vehicle, respectively, or from an auxiliary compressor.

Generally, the invention makes it possible to increase by approximately 70% the friction of the air on the wall, downstream of the aforementioned orifices, while consuming, according to the configurations, approximately two to five times less air than an equivalent device with continuous jets.

The invention shall be better understood and other characteristics, details and advantages of the latter shall appear more clearly when reading the following description, given by way of example in reference to the annexed drawings wherein:

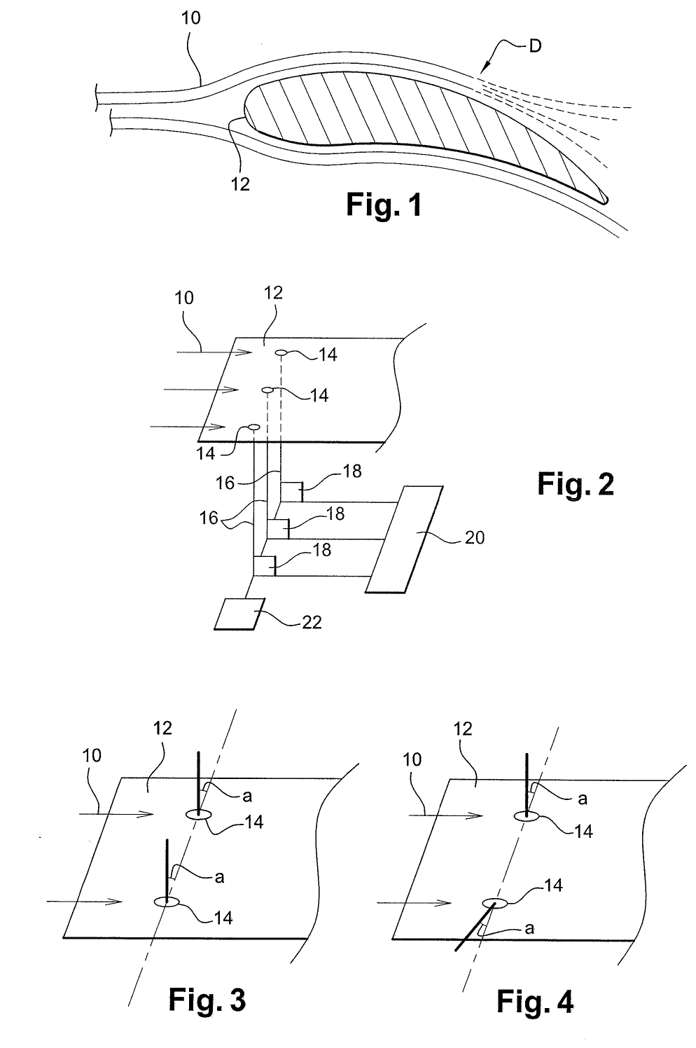

FIG. 1 schematically shows an air flow on a 20 profiled wall such as an aircraft wing;

FIG. 2 schematically shows the essential means of a device according to the invention;

FIGS. 3 and 4 show respectively orifices with co-rotating and contra-rotating jets;

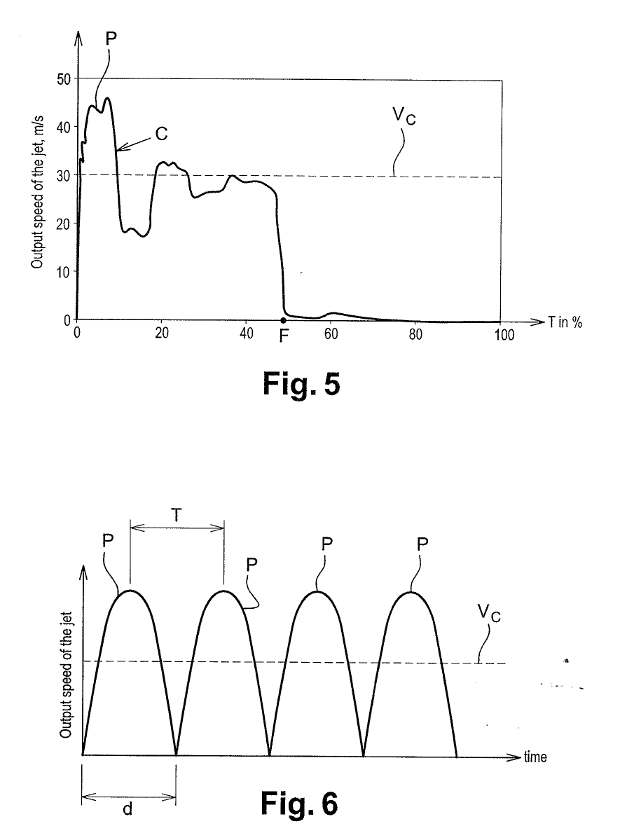

FIG. 5 is a graph showing the variation of the speed of a pulsed jet during the duration of a cycle of opening and closing of a valve;

FIG. 6 is a graph representing the variation of the output speed of a pulsed jet according to the time in the device according to the invention;

FIG. 7 is a schematic cross-section view of a rotating distributor for supplying pressurized air.

In FIG. 1, an air flow 10 is shown schematically on a profiled wall 12 such as an aircraft wing with a boundary layer separation in a zone D of the wing upper surface, this separation resulting in a reduction of the lift and by an increase in the drag and therefore in a degradation of the aerodynamic performance of the aircraft.

In order to delay this separation, the device according to the invention comprises at least one row of orifices 14 which are formed in the wall 12 along a line perpendicular to the flow 10 and which are supplied with pressurized air by tubes or ducts 16 connected by solenoid valves 18 to a source 20 of pressurized air, this air being bled from a compressor of an aircraft engine or from a auxiliary compressor.

The jets of pressurized air exiting the orifices 14 generate vortices which have for effect to increase the friction of the air on the wall 12 in the boundary layer and therefore to delay the separation of this boundary layer.

The studies that have been carried out by various authors on continuous jet or pulsed jet devices have shown that good results can be obtained when the vortices produced rotate in the same direction, which is obtained when the axes of the orifices 14 are inclined by the same angle a and in the same direction in relation to the wall 12, as shown in FIG. 3, the vortices can also be contra-rotating, which is obtained when the axes of the orifices 14 are inclined by the same angle a in relation to the wall 12 but in pairs in opposite directions as shown schematically in FIG. 4, this angle able to be positive or negative and between −45° and +45°.

In a preferred embodiment, the orifices 14 are cylindrical with a circular section, their axes are perpendicular to the general direction of the flow 10 and their angle of inclination in relation to the wall 12 is 45°.

The valves 18 are controlled in opening and in closing cyclically, for example by a microprocessor system 22, in order to produce, pulsed jets at the output of the orifices 14. The variation in the output speed of a pulsed jet during the duration T of a cycle of opening and of closing of the corresponding valve, is shown by the curve C in FIG. 5. It can be seen that a peak in speed P occurs at the beginning of the opening of the valve after which the output speed of the jet oscillates and approaches a value Vc which corresponds to the output speed of a continuous jet exiting the same orifice supplied by the same air pressure, the speed then cancelling out when the valve is closed in F at a moment which corresponds to 50% of the duration T of the cycle of opening and of closing, in the example shown.

At peak P, the output speed of the pulsed jet is greater by about 50% than of the speed Vc of a continuous jet generated in the same conditions, the speed peak being due to an acoustic phenomenon in the tube 16 at the opening of the valve 18.

According to the invention, the duration d of opening of the valve in a cycle and the frequency 1/T of the opening and closing cycles of the valve are determined in such a way that the speed peaks P in the various opening cycles follow one another quasi-continuously as shown schematically in FIG. 6.

An optimal value for d is between 5 and 10 ms, the frequency of the opening and closing cycles of the valves being between 30 and 200 Hz.

Preferably, the duration of opening of the valves is in the vicinity of 5 ms and the frequency of the opening and closing cycles of the valves is in the vicinity of 70 Hz.

The length of the tubes 16 is chosen to increase the value of the peak in speed P, which can reach up to 170% of the speed Vc of a continuous jet produced in the same conditions, this length of tube being generally between 0.1 and 1 m approximately, the diameter of the orifices 14 being between 1 and 10 mm.

When the orifices 14 are supplied as shown schematically in FIG. 6, the total flow of compressed air is equal to approximately 35% of the flow of the continuous jets at the same supply pressure. For a (relative) supply pressure of 2 bars, the output speed of the pulsed jets reaches a maximum value of 70 m/s. The gain in friction in the boundary layer, downstream of the orifices 14, is then of a magnitude of 70%.

FIG. 7 schematically shows means of supplying orifices 14 with pressurized air, these means comprising in place of the valves 18 a rotating distributor 28 connected to the source of pressurized air 20 by the tip 29 and to ducts 16 leading to the orifices 14.

The distributor 28 comprises a cylindrical tube 30 which is mounted rotating about its axis in a cylindrical housing 32 and which is driven in rotation by an electric engine 34 controlled by a microprocessor system, such as the system 22 in FIG. 2.

The cylindrical tube 30 is supplied with pressurized air at one of its ends by the source 20 and comprises annular rows of radial holes 36 for the passage of compressed air. The housing 32 comprises radial holes 38 which are axially aligned with the rows of radial holes 36 of the rotating tube 30 in such a way as to be cyclically supplied with pressurized air and blocked off during the rotation of the tube 30.

The pulse frequency of this distributor is defined by the product of the rotation speed of the rotating tube 30 and of the number of holes 36 passing in front of a hole 38 of the housing during one turn of rotation of the tube.

In the device according to the invention, the gain in friction in the boundary layer, downstream of the orifices 14, is proportional to the quantity of movement injected which depends linearly on the DC (Duty Cycle) for a given ratio of the speed of the jets at the output of the orifices 14 and of the speed of the infinite flow upstream. In the device in FIG. 2, the DC is equal to the ratio between the injection time d and the frequency T of the cycle. In the alternative embodiment in FIG. 7, the DC is equal to the ratio between the diameter of the holes 36 of the rotating tube and the sum of their diameter and of their circumferential spacing around the axis of the tube.

One of the advantages of the distributor 28 in FIG. 7 is the very strong improvement in output: the charge losses are reduced for the obtaining of a high 30 speed at the output of the orifices 14, for flow rates which are very low. The relative supply pressure is between 0 and 1.4 bars for speeds at the output of the orifices 14 which can reach the speed of sound. For a relatively low supply pressure of 0.4 bars, high jet speeds of approximately 0.7 times the speed of sound are obtained at the output of the orifices 14.

Another advantage of the distributor 28 is its compactness which allows it to be housed easily inside an aircraft wing.

1. A device for delaying the separation of a boundary layer in a flow of air on a wall, comprising orifices formed in the wall with an inclination determined in relation to the direction of the flow on the wall and in relation to the surface of the wall, ducts connecting these orifices to compressed air supply means, and means for controlling opening and as closing of the compressed air supply means, wherein the frequency of the opening and closing cycles of the compressed air supply means and the duration of opening in each cycle are selected so as to generate peak output velocities from the orifices which occur in quasi-continuous succession.

2. A device as set forth in claim 1, wherein the duration of opening of the compressed air supply means is between 5 and 10 ms.

3. A device as set forth in claim 1, wherein the duration of opening of the means of supplying is approximately 5 ms.

4. A device according to claim 1, wherein the frequency of the opening and closing cycles of the compressed air supply means is between 30 and 200 Hz.

5. A device according to claim 1, wherein the frequency of the opening and closing cycles of the compressed air supply means is approximately 70 Hz.

6. A device according to claim 1, wherein the relative pressure of the air supplying the orifices is between approximately 1 and 8 bars.

7. A device according to claim 1, wherein the diameter of the orifices is between 1 and 10 mm.

8. A device according to claim 1, wherein the length of the ducts connecting the orifices to the compressed air supply means is between 0.1 and 1 m.

9. A device according to claim 1, wherein the axes of the orifices are inclined in the same direction in relation to the wall or are inclined in pairs of a same angle in opposite directions in relation to the wall.

10. A device according to claim 1, wherein the compressed air supply means include solenoid valves connected to a source of pressurized air.

11. A device according to claim 1, wherein the compressed air supply means include a rotating tube comprising rows of radial holes and supplied with pressurized air, this tube being driven in rotation in a cylindrical housing comprising radial output holes which are connected by ducts to the orifices of the wall and which are aligned axially with the holes of the rotating tube in order to be cyclically supplied with pressurized air and blocked off during the rotation of the rotating tube.

12. A device according to claim 1, in combination with an aircraft wing or a motor vehicle body.

13. A device as set forth in claim 12, wherein the compressed air supplying the orifices of the wall is bled from the aircraft engine or from the motor vehicle or is supplied by an auxiliary compressor.
